(19) United States
(12) Patent Application Publication
(10) Pub. No.: US 2026/0330105 A1
(43) Pub. Date: Oct. 22, 2026

(54) DIGITAL TWIN SIMULATION-BASED OPERATION OPTIMIZATION SYSTEM AND FACILITY OPERATION SYSTEM INCLUDING THE SAME

(71) Applicants: Samsung Display Co., Ltd., Yongin-si (KR); Research & Business Foundation SUNGKYUNKWAN UNIVERSITY, Suwon-si (KR)

(72) Inventors: Seki Park, Yongin-si (KR); Whan Lee, Suwon-si (KR); Junwoo Lim, Suwon-si (KR); Hyeonji Son, Yongin-si (KR); Sanghwa Lee, Yongin-si (KR); Junghoon Kim, Yongin-si (KR); Dongwon Han, Yongin-si (KR); Sangdo Noh, Suwon-si (KR); Hyunseok Lee, Suwon-si (KR); Seoyoung Jo, Suwon-si (KR); Eunyoung Choi, Suwon-si (KR)

(21) Appl. No.: 19/649,743

(22) Filed: Apr. 16, 2026

(30) Foreign Application Priority Data
Apr. 17, 2025 (KR) 10-2025-0050413

(51) Int. Cl. G06F 30/27; G06F 111/04

(52) U.S. Cl. CPC G06F 30/27; G06F 2111/04

(57) ABSTRACT

An operation optimization system includes a digital twin simulation module which performs a digital twin simulation based on an operation rule, real-time data, and a facility constraint switching condition and outputs daily production operation information, a reinforcement learning module which selects one of a plurality of operation rules, learns a selection for maximizing a final production for a certain period based on the daily production operation information based on the selected operation rule, and determines an operation plan by using a learned algorithm, and an interface module which transmits information between the digital twin simulation module and the reinforcement learning module.

This application claims priority to Korean Patent Application No. 10-2025-0050413, filed on Apr. 17, 2025, and all the benefits accruing therefrom, the content of which in its entirety is herein incorporated by reference.

### BACKGROUND

### 1. Field

One or more embodiments relate to a digital twin simulation-based operation optimization system and a facility operation system including the digital twin simulation-based operation optimization system.

### 2. Description of the Related Art

Digital twin is a technology for reproducing a facility and/or a process as a digital image like in an actual plant. A situation that may occur in an actual plant may be tested in a virtual digital twin plant by using a digital twin simulation module, and the state of an actual plant facility may be predicted and diagnosed by using data obtained from the simulation.

A digital twin simulation module may integratively reflect static data such as facility specifications, operation conditions, drawings, and technical documents of a plant, and real-time data collected from sensors and facilities of an actual plant. Thus, the digital twin simulation module may provide a platform in which workers may monitor and collaborate in real time in various positions such as central control rooms, maintenance technology rooms, and fields.

Research has been conducted on a digital twin simulation-based operation optimization system to maximize facility operation efficiency in various fields such as production of display devices and production of semiconductor devices.

### SUMMARY

In the related art, a digital twin simulation module has difficulty in immediately responding to changing environments such as facility maintenance and thus performs only limited functions such as data analysis and short-term prediction on the state of the facility. However, these problems are merely examples and the scope of the disclosure is not limited thereto.

One or more embodiments include an operation optimization system for deriving an optimal operation plan by training a reinforcement learning module by using a digital twin simulation module that considers a facility constraint (Track In Prevent (TIP)), and a facility operation system including the operation optimization system.

According to one or more embodiments, an operation optimization system includes a digital twin simulation module which performs a digital twin simulation based on an operation rule, real-time data, and a facility constraint switching condition and outputs daily production operation information, a reinforcement learning module which selects one of a plurality of operation rules, learn a selection for maximizing a final production for a certain period based on the daily production operation information of a digital twin simulation performed based on the selected operation rule, and determines an operation plan by using a learned algorithm, and an interface module which transmits information between the digital twin simulation module and the reinforcement learning module.

In an embodiment, the digital twin simulation module may assign a rank to each of a plurality of facilities based on the selected operation rule and select a work facility based on the rank.

In an embodiment, the digital twin simulation module may select a facility with a highest rank among the plurality of facilities as the work facility and evaluate the facility constraint switching condition of the selected facility to perform a work with the selected facility or to select a next-rank facility as the work facility.

In an embodiment, the reinforcement learning module may select one of the plurality of operation rules per day for one episode including the certain period, the digital twin simulation module may output the daily production operation information based on the selected operation rule, and the reinforcement learning module may repeatedly learn a plurality of episodes and determine a combination of the operation rules which maximizes the final production as the operation plan.

In an embodiment, the reinforcement learning module may generate an operation state based on the daily production operation information, predict an expected reward obtained by selecting one of the plurality of operation rules in the operation state, and learn by comparing the expected reward with a daily production of the daily production operation information.

In an embodiment, the reinforcement learning module may store, in a replay memory, experiences obtained in a learning process and learn by randomly sampling a mini-batch from the replay memory.

In an embodiment, the reinforcement learning module may include a main network and a target network, and the target network may copy a weight of the main network at certain periods, maintain the copied weight until a next period, and output a maximum expected reward.

In an embodiment, the reinforcement learning module may further include a loss calculator which calculates a loss function based on a difference between the expected reward and the maximum expected reward and updates the weight of the main network based on the calculated loss.

In an embodiment, the main network may estimate an expected reward in an operation state based on the maximum expected reward.

In an embodiment, the reinforcement learning module may estimate an n-th-rank expected reward based on an n-th-greatest value among expected rewards of a next operation state, where n is a natural number equal to or greater than 1.

In an embodiment, the reinforcement learning module may determine a next-best operation rule which is applicable when a facility constraint of a selected facility based on the operation rule is not releasable.

According to one or more embodiments, a facility operation system includes a data collection system which collects real-time data from a production line, a data management system which stores the real-time data, and an operation optimization system which performs a digital twin simulation based on the real-time data and determine an operation plan of the production line based on result values of the digital twin simulation, where the operation optimization system includes a digital twin simulation module which performs a digital twin simulation based on an operation rule, real-time data, and a facility constraint switching condition and outputs daily production operation information, a reinforcement learning module which selects one of a plurality of operation rules, learns a selection for maximizing a final production for a certain period based on the daily production operation information of a digital twin simulation performed based on the selected operation rule, and determines an operation plan by using a learned algorithm, and an interface module which transmits information between the data management system, the digital twin simulation module, and the reinforcement learning module.

In an embodiment, the interface module may transmit the real-time data from the data management system to the digital twin simulation module, transmit the daily production operation information from the digital twin simulation module to the reinforcement learning module, and transmit the selected operation rule from the reinforcement learning module to the digital twin simulation module.

In an embodiment, the data collection system may include sensors and an Internet of Things (IoT) network.

In an embodiment, the data management system may store facility information, product information, plan information, process information, and operation information.

In an embodiment, the digital twin simulation module may assign a rank to each of a plurality of facilities based on the selected operation rule and select a work facility based on the rank.

In an embodiment, the digital twin simulation module may select a facility with a highest rank among the plurality of facilities as the work facility and evaluate the facility constraint switching condition of the selected facility to perform a work with the selected facility or to select a next-rank facility as the work facility.

In an embodiment, the reinforcement learning module may select one of the plurality of operation rules per day for one episode including the certain period, the digital twin simulation module may output the daily production operation information based on the selected operation rule, and the reinforcement learning module may repeatedly learn a plurality of episodes and determine a combination of the operation rules which maximizes the final production as the operation plan.

In an embodiment, the reinforcement learning module may generate an operation state based on the daily production operation information, predict an expected reward obtained by selecting one of the plurality of operation rules in the operation state, and learn by comparing the expected reward with a daily production of the daily production operation information.

In an embodiment, the reinforcement learning module may determine a next-best operation plan which is applicable when a facility constraint of a work facility based on the operation plan is not releasable.

These general and particular features of embodiments may be implemented by using systems, methods, computer programs, or any combinations of systems, methods, and computer programs.

### BRIEF DESCRIPTION OF THE DRAWINGS

The above and other features of certain embodiments of the disclosure will be more apparent from the following description taken in conjunction with the accompanying drawings, in which:

FIG. 1 is a diagram schematically illustrating a digital twin simulation-based facility operation system according to an embodiment;

FIG. 2 is a diagram schematically illustrating an operation optimization system according to an embodiment;

FIG. 3 is a diagram for schematically describing a reinforcement learning module according to an embodiment;

FIG. 4 is a flowchart schematically illustrating an operation plan derivation method using an operation optimization system according to an embodiment;

FIG. 5 is a flowchart schematically describing an execution operation of a digital twin simulation module according to an embodiment;

FIG. 6 is a diagram illustrating an example of facilities according to an embodiment;

FIG. 7 is a flowchart schematically describing an operation plan derivation operation according to an embodiment; and

FIG. 8 is a graph illustrating a learning curve of a reinforcement learning module according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The disclosure may include various embodiments and modifications, and particular embodiments thereof are illustrated in the drawings and will be described herein in detail. The effects and features of the disclosure and methods of achieving them will become apparent with reference to the embodiments described below in detail together with the drawings. However, the disclosure is not limited to the embodiments described below and may be implemented in various forms.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Also, “at least one of A and B” or “at least one selected from A and B” represents the case of A, B, or A and B. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “on” another element, it can be directly on the other element or intervening elements may be present therebetween. In contrast, when an element is referred to as being “directly on” another element, there are no intervening elements present.

It will be understood that when a layer, region, or component is referred to as being “connected to” another layer, region, or component, it may be “directly connected to” the other layer, region, or component or may be “indirectly connected to” the other layer, region, or component with one or more intervening layers, regions, or components therebetween.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below . . . .

Herein, when a certain embodiment may be implemented differently, a particular process order may be performed differently from the described order. For example, two consecutively described processes may be performed substantially at the same time or performed in an order opposite to the described order.

Sizes of elements in the drawings may be exaggerated for convenience of description. In other words, because the sizes and shapes of elements in the drawings are arbitrarily illustrated for convenience of description, the disclosure is not limited thereto.

Herein, some embodiments may be described as functional blocks and various processing operations. Some or all of these functional blocks may be implemented by any number of hardware and/or software components that execute a particular function. The functional blocks may be implemented by one or more processors or may be implemented by circuit configurations for a certain function. Alternatively, the functional blocks may be implemented in various programming or scripting languages. Alternatively, the functional blocks may be implemented as an algorithm executed in one or more processors.

Herein, a function performed by a functional block may be performed by a plurality of functional blocks, and likewise, a function performed by a plurality of functional blocks may be performed by a functional block. Also, the disclosure may employ the related art for electronic environment setting, signal processing, and/or data processing.

Herein, the term such as “unit” or “module” may refer to a unit for processing at least one function or operation, which may be implemented by hardware, software, or a combination of hardware and software.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

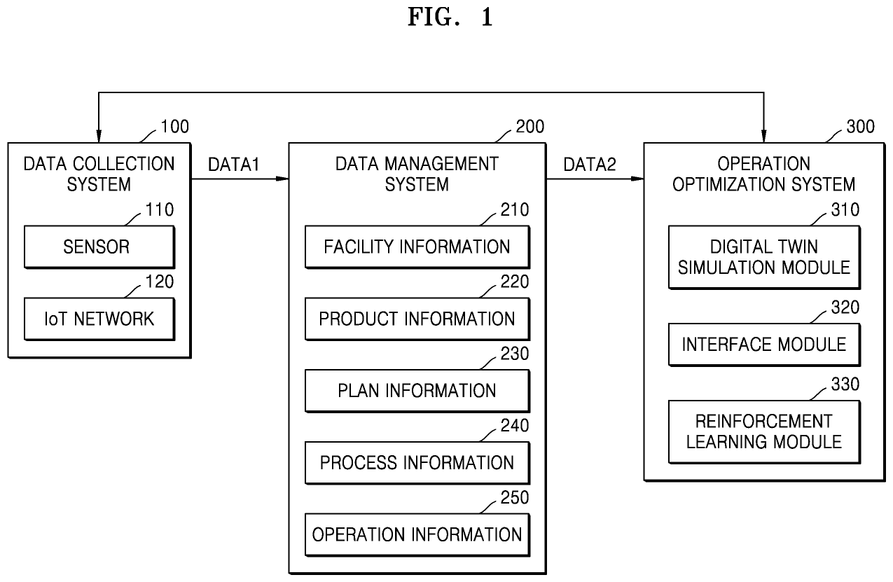

FIG. 1 is a diagram schematically illustrating a digital twin simulation-based facility operation system according to an embodiment.

Referring to FIG. 1, a facility operation system 1 according to an embodiment may include a data collection system 100, a data management system 200, and an operation optimization system 300.

The data collection system 100 may include sensors 110 and an Internet of Things (IoT) network 120 arranged in a plant and/or a production line. The data collection system 100 may obtain, through the sensors 110 and the IoT network 120, information generated from various facilities, devices, parts, or the like included in the plant and information provided by workers.

The sensors 110 may include various sensors for detecting various information about the plant (e.g., environment, facility, and worker information). In an embodiment, for example, the sensors 110 may include at least one selected from a temperature sensor, a humidity sensor, a pressure sensor, a flow rate sensor, a magnetic sensor, a light sensor, a sound sensor, an image sensor, a current sensor, and a gas sensor arranged in the plant.

In an embodiment, the sensors 110 may include positioning sensors for detecting position information of the workers or Work in Process (WIP) in real time. The sensors 110 may include a photoelectric sensor, an ultrasonic sensor, a gate-type sensor, a thermal sensor, a laser sensor, a lidar sensor, a WiFi sensor, a beacon sensor, an ultra-wideband (UWB) sensor, a Bluetooth sensor, an image analysis sensor, a radio frequency identification (RFID) sensor, or a camera.

The facilities and the sensors 110 of the plant may be connected to the IoT network 120 through various communication methods such as WiFi, Bluetooth, RFID, and intranet cables to collect and share data in real time. Through the IoT network 120, the sensors 110, the facilities, or smart devices may interact with each other. In an embodiment, for example, based on the state or production of a particular facility, the operation of another facility may be automatically controlled.

The data management system 200 may systematically store and manage real-time data DATA1 obtained by the data collection system 100 through the sensors 110 and the IoT network 120 of an actual plant. Also, the data management system 200 may store and manage technical data (or static data) such as facility specifications, operation conditions, drawings, and technical documents of the plant. In an embodiment, for example, the data management system 200 may systematically store and manage the real-time data DATA1 and the technical data by integratively classifying the real-time data DATA1 and the technical data into facility information 210, product information 220, plan information 230, process information 240, and operation information 250.

The facility information 210 may include positions, installation dates, standards, specifications, operation information, maintenance history information, or facility constraint state information of the facilities included in the plant and/or the production line. Here, the facility constraint may refer to an operation constraint condition that restricts the input of WIP to a particular facility in a production process. In an embodiment, for example, the facility constraint may refer to a constraint that is releasable only when a particular condition is satisfied, due to maintenance of the facility, quality issues, or the like.

The product information 220 may include specifications of products produced by the plant and/or the production line, specifications of intermediate products, design information, production information, or inventory information. The plan information 230 may include production plans, process plans, material management plans, or facility maintenance plans. The process information 240 may include process parameter data such as temperature, pressure, and flow rate measured in real time, process progress stages, process control setting values, process control algorithms, process history data, or process manuals. The operation information 250 may include an operation plan, the operation state and production of the plant, operation efficiency analysis and optimization results, a facility constraint switching condition, or facility failure prediction data. Here, the facility constraint switching condition may refer to data and/or logic about a particular condition for releasing the facility constraint of the facility.

In an embodiment, the operation optimization system 300 may include a digital twin simulation module 310, an interface module 320, and a reinforcement learning module 330.

The facility information 210, the product information 220, the plan information 230, the process information 240, and the operation information 250 from the data management system 200 may be transmitted to the interface module 320, and the interface module 320 may convert them into standard information DATA2 for configuring a simulation environment by the digital twin simulation module 310 and transmit the standard information DATA2 to the digital twin simulation module 310. The standard information DATA2 may include a facility constraint switching condition and the real-time data DATA that reflects the state of an actual plant in real time.

The interface module 320 may transmit information between the digital twin simulation module 310 and the reinforcement learning module 330. In an embodiment, for example, the interface module 320 may convert an action selected from the reinforcement learning module 330 into an operation rule applicable to the digital twin simulation module 310 and transmit the operation rule to the digital twin simulation module 310. Herein, the operation rule may refer to a standard for selecting one of a plurality of facilities constituting the production line. Hereinafter, selecting the operation rule by the reinforcement learning module 330 may include converting an action selected from the reinforcement learning module 330 into an operation rule applicable to the digital twin simulation module 310 or an actual plant and transmitting the operation rule thereto by the interface module 320.

Also, the interface module 320 may convert daily production operation information output through the simulation by the digital twin simulation module 310 into information usable by the reinforcement learning module 330 and transmit the information to the reinforcement learning module 330.

The digital twin simulation module 310 may generate a digital twin plant by digitally implementing the same environment as the actual plant based on the standard information DATA2 received from the interface module 320. The digital twin plant may include virtual facilities, devices, and parts corresponding to facilities, devices, and parts included in an actual plant.

The digital twin simulation module 310 may perform a simulation based on the standard information DATA2 and the operation rule and output daily production operation information. The digital twin simulation module 310 may select a work facility based on the operation rule and, when the selected facility is in a facility constraint state, evaluates the facility constraint switching condition of the selected facility to perform a work with the selected facility or select a next-rank facility as a work facility.

The interface module 320 may transmit the daily production operation information to the reinforcement learning module 330. The reinforcement learning module 330 may learn a selection for maximizing a final production for a certain period based on the daily production operation information and determine an operation plan by using a learned algorithm. The certain period may be defined as one episode, and in an embodiment, one episode may include 10 days.

The reinforcement learning module 330 may select an operation rule per day, and the digital twin simulation module 310 may output new daily production operation information by re-performing the simulation based on the newly-synchronized standard information DATA2 and the operation rule. By repeating the episode a certain number of times, the reinforcement learning module 330 may learn to derive an optimal operation plan for maximizing a final production for one episode. Here, the operation plan may be a selected combination of operation rules for one episode. In an embodiment, for example, when one episode includes 10 days, the operation plan may be a selected combination of operation rules selected for 10 days. By using the learned algorithm, the reinforcement learning module 330 may determine an optimal operation plan applicable to an actual plant and/or a production line.

In an embodiment, the reinforcement learning module 330 may determine and propose a next-best operation plan that is applicable when the facility constraint of the selected facility based on the optimal operation plan for maximizing the final production for one episode is not releasable.

According to an embodiment, because the digital twin simulation module 310 performs a simulation based on the operation rule and the facility constraint switching condition, the reinforcement learning module 330 trained by using the simulation may derive an optimal operation plan considering the facility constraint. The operation plan derived by the reinforcement learning module 330 may be transmitted to an actual plant to be directly reflected in the operation of an actual facility or to be used as decision-making information for operation. The facility operation system 1 is not limited to the operation of a particular process or production line and may be widely used throughout the entire production plant.

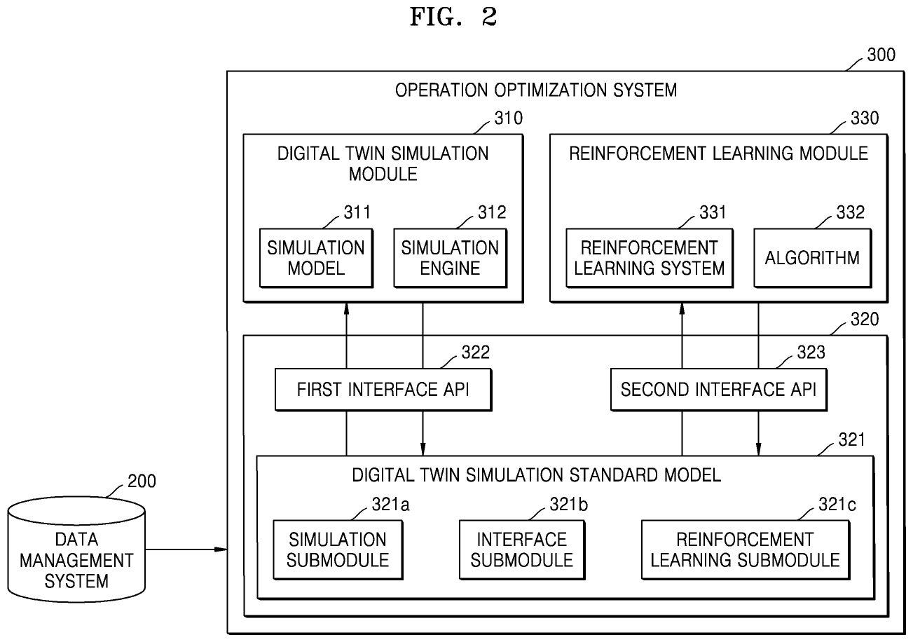

FIG. 2 is a diagram schematically illustrating an operation optimization system according to an embodiment.

Referring to FIG. 2, an embodiment of the operation optimization system 300 may include a digital twin simulation module 310, an interface module 320, and a reinforcement learning module 330.

The digital twin simulation module 310 may include a simulation model 311 and a simulation engine 312. The simulation model 311 may include operation logic, movement control logic, or facility constraint switching logic. The operation logic may model the process order, work time, resource allocation, or the like of the digital twin plant, and the movement control logic may model the transport path, movement time, speed, or the like of the WIP. When the selected facility is in a facility constraint state, the facility constraint switching logic may evaluate a condition of whether the facility constraint is releasable and release the facility constraint of the selected facility and switch to an available state when the condition is satisfied or maintain the facility constraint state when the condition is not satisfied.

The simulation engine 312 may include a synchronization unit, an operation plan application unit, a simulation execution unit, or a simulation termination unit. The synchronization unit may synchronize data of the actual plant with data of the digital twin plant in real time by reflecting the standard information DATA2 received through the interface module 320 to the digital twin plant. The operation plan application unit may reflect the operation rule selected by the reinforcement learning module 330 to the simulation. The simulation execution unit may execute the simulation model 311 and generate result values thereof, and the simulation termination unit may terminate the execution of the simulation model 311 and output result values thereof.

The interface module 320 may include a digital twin simulation standard model 321, a first interface application programming interface (API) 322, and a second interface API 323. The digital twin simulation standard model 321 may comply with the ISO23247 international standard, and the interface module 320 may support the data management system 200, the digital twin simulation module 310, and the reinforcement learning module 330 to consistently and efficiently exchange data with each other.

The digital twin simulation standard model 321 may include a simulation submodel 321a, an interface submodel 321b, and a reinforcement learning submodel 321c. The simulation submodel 321a may define information input to the digital twin simulation module 310 and information output from the digital twin simulation module 310. The information input to the digital twin simulation module 310 may include the facility information 210, the product information 220, the plan information 230, the process information 240, and the operation information 250 received from the data management system 200. The information output from the digital twin simulation module 310 may include the simulation result values. The simulation result values may be converted into the daily production operation information including day, turnaround time (TAT), facility constraint release count, work in process (WIP), WIP count, or daily production.

In order to define data exchange between external systems or submodels such as the data management system 200, the interface submodel 321b may perform input/output mapping by assigning input data (ID) and output data (OD). Also, the interface submodel 321b may define a state switching condition of the digital twin simulation module 310 and define a condition on which the digital twin simulation module 310 interacts with the data management system 200 or the reinforcement learning module 330.

The reinforcement learning submodel 321c may include information input to the reinforcement learning module 330 and information output from the reinforcement learning module 330. The information input to the reinforcement learning module 330 may include state information, reward information, or parameters, and the information output from the reinforcement learning module 330 may include action information. The state information may be configured based on daily production operation information output by the digital twin simulation module 310. The reward information may be a daily production output by the digital twin simulation module 310. The parameters may be values used for learning or setting of the reinforcement learning module 330 and may include weights. The action information may be information about an action of selecting one of a plurality of operation rules.

The first interface API 322 and the second interface API 323 may mediate the data exchange between the data management system 200 and the digital twin simulation module 310 and between the digital twin simulation module 310 and the reinforcement learning module 330 based on the digital twin simulation standard model 321. The interface module 320 may ensure the compatibility between an external system and a submodule to allow smooth data exchange therebetween. Also, the interface module 320 may independently develop and maintain the respective modules or minimize the influence on the entire system when adding a new component to the system.

The reinforcement learning module 330 may include a reinforcement learning system 331 and an algorithm 332. The reinforcement learning system 331 may include an agent, a neural network, and a replay memory (or a replay buffer). The agent may learn based on the algorithm and find an optimal policy. The neural network may receive an input of a current state to predict an expected reward (or a Q-value) of each action. The replay memory may store the agent's experiences obtained in the learning process, and the agent may improve the stability of the neural network by learning by randomly sampling a mini-batch from the replay memory.

The algorithm 332 may include an initialization algorithm, an action selection algorithm, an experience storage algorithm, or a Q-value update algorithm. The initialization algorithm may initialize the weights, replay memory, parameters, or the like of the neural network. The action selection algorithm may select an optimal action based on the expected reward. The experience storage algorithm may store, in the replay memory, the agent's experiences obtained in the learning process. By using the experience extracted from the replay memory, the Q-value update algorithm may update the weights of the neural network in the direction of minimizing a loss function.

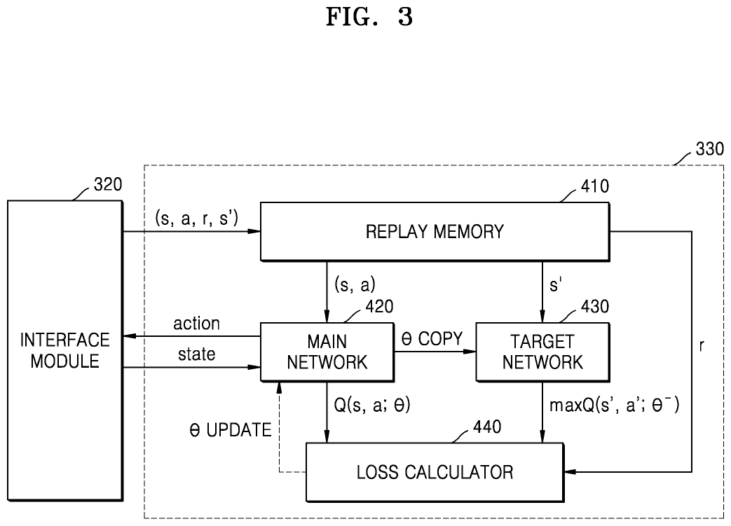

FIG. 3 is a diagram for schematically describing a reinforcement learning module according to an embodiment.

Referring to FIG. 3, an embodiment of the reinforcement learning module 330 may include a replay memory 410, a main network 420, a target network 430, and a loss calculator 440.

The reinforcement learning module 330 may receive, from the interface module 320, the daily production operation information output by the digital twin simulation module 310 (see FIG. 2). Based on the daily production operation information, the reinforcement learning module 330 may derive an operation state s, an action a, an immediate reward r obtained when performing the action a in the current state, and a next operation state s′ to be reached after performing the action a. The operation state s, the action a, the reward r, and the next operation state s′ obtained by the agent of the reinforcement learning module 330 in the learning process may be stored in the replay memory 410.

The neural network of the reinforcement learning module 330 may include a main network 420 and a target network 430. The main network 420 may receive an input of the operation state s and action a and output an expected reward Q(s, a; θ) for each action to the loss calculator 440. Here, θ may be a weight of the neural network.

The target network 430 may be a neural network having the same structure as the main network 420 and may copy the weight θ of the main network 420 at certain periods and maintain the same until the next period. The target network 430 may receive an input of the next operation state s′ and output, to the loss calculator 440, a maximum expected reward maxQ(s′, a′; θ−) that is the greatest value among the expected rewards for an action a′ that may be selected in the next operation state s′. Here, θ− may be a weight of the target network 430. A Bellman equation may be stably applied by using the target network 430.

That is, the reinforcement learning module 330 may predict the expected reward Q(s, a; θ) by using Equation 1 below.

Q(s, a; θ)=E[(r+γ×maxQ(s′, a′; θ−))] [Equation 1]

In Equation 1, γ denotes a discount factor for determining the importance of future rewards, and satisfies the following inequality: 0≤γ≤1. A function of deriving the optimal expected reward Q(s, a; θ) may be calculated as a value that satisfies the Bellman equation. The Bellman equation may provide an equation for updating a state-action value function (Q function).

The loss calculator 440 may calculate a loss function based on the difference between the expected reward Q(s, a; θ) and the maximum expected reward maxQ(s′, a′; θ−), and update the weight θ of the main network 420 based on the calculated loss. By using the loss function, a temporal difference (TD) loss (or TD error) may be minimized. The loss function of the loss calculator 440 may be the same as that in Equation 2 below.

L(θ)=E_{s,a,r,s′}[(r+γ×maxQ(s′, a′; θ−)−Q(s, a; θ)] [Equation 2]

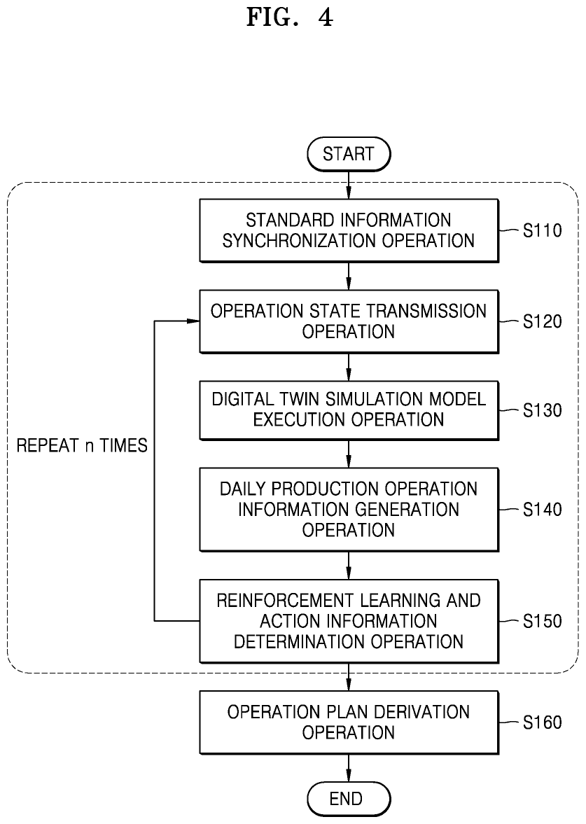

FIG. 4 is a flowchart schematically illustrating an operation plan derivation method using an operation optimization system according to an embodiment.

Referring to FIG. 4, an embodiment of the operation plan derivation method may include a standard information synchronization operation S110, an operation state transmission operation S120, a digital twin simulation model execution operation S130, a daily production operation information generation operation S140, a reinforcement learning and action information determination operation S150, and an operation plan derivation operation S160.

In the standard information synchronization operation S110, the data management system 200 may systematically classify and manage the real-time data and the technical data collected from the actual plant and/or the production line. The interface module 320 may convert the facility information 210 (see FIG. 1), the product information 220 (see FIG. 1), the plan information 230 (see FIG. 1), the process information 240 (see FIG. 1), and the operation information 250 (see FIG. 1) into the standard information DATA2 (see FIG. 1) for configuring a simulation environment by the digital twin simulation module 310 and transmit the standard information DATA2 to the digital twin simulation module 310. The digital twin simulation module 310 may reproduce the production line in the digital twin plant based on the standard information DATA2.

In the operation state transmission operation S120, the digital twin simulation module 310 may configure, based on the standard information DATA2, the daily production operation information including day, TAT, facility constraint release count, WIP, WIP count, or daily production and transmit the daily production operation information to the reinforcement learning module 330 through the interface module 320. The reinforcement learning module 330 may configure the operation state s based on the daily production operation information and perform learning by using the neural network. The reinforcement learning module 330 may determine the learned action a based on the operation state s and transmit the learned action a to the digital twin simulation module 310 through the interface module 320. The interface module 320 may convert the action a information of the reinforcement learning module 330 into an operation rule applicable to the digital twin simulation module 310 and transmit the operation rule thereto.

In the digital twin simulation model execution operation S130, the digital twin simulation module 310 may perform a digital twin simulation by applying the operation rule received through the interface module 320. The digital twin simulation module 310 may select the next work facility to which the WIP should move based on the operation rule. In an embodiment, for example, the digital twin simulation module 310 may assign a rank to each of a plurality of facilities based on the operation rule and select a work facility based on the rank. In this operation, when the selected facility is in a facility constraint state, the facility constraint switching condition may be evaluated to perform a work with the selected facility or select a next-rank facility as a work facility.

In the daily production operation information generation operation S140, the digital twin simulation module 310 may virtually reproduce a work situation of the work facility and derive daily production operation information. In this operation, the daily production operation information may include a daily production, and the interface module 320 may convert the daily production into reward r information for learning of the reinforcement learning module 330 and transmit the reward r information to the reinforcement learning module 330.

In the reinforcement learning and action information determination operation S150, the reinforcement learning module 330 may store the operation state s and action a information in the replay memory by using the daily production as the reward r and update the neural network based on the stored operation state s, action a, and reward r. By using the continuously-updated neural network, the reinforcement learning module 330 may return the daily action a information based on the daily operation state s information and derive an action a combination for maximizing a total production for a certain period. In an embodiment, the certain period may include 10 days. This process may be configured as one episode, and learning may be performed by repeating the episode a preset number of times (n times).

In the operation plan derivation operation S160, the reinforcement learning module 330 that has completed the learning may determine an action combination for maximizing the final production finally derived, that is, an operation plan, and the determined operation plan may be transmitted to the actual plant and/or the production line to be directly applied or to be used as reference data for decision making.

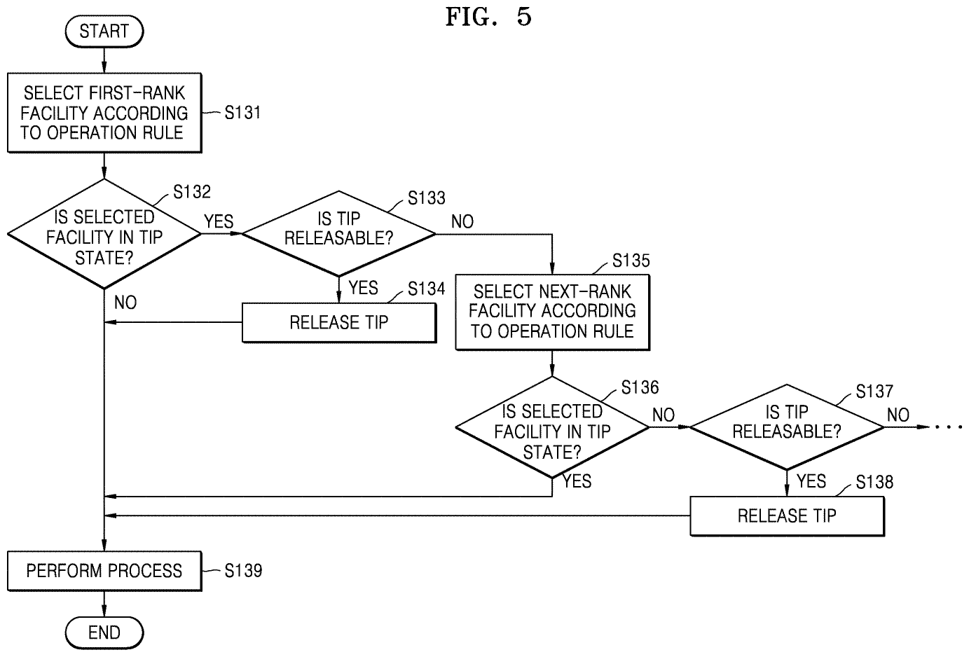

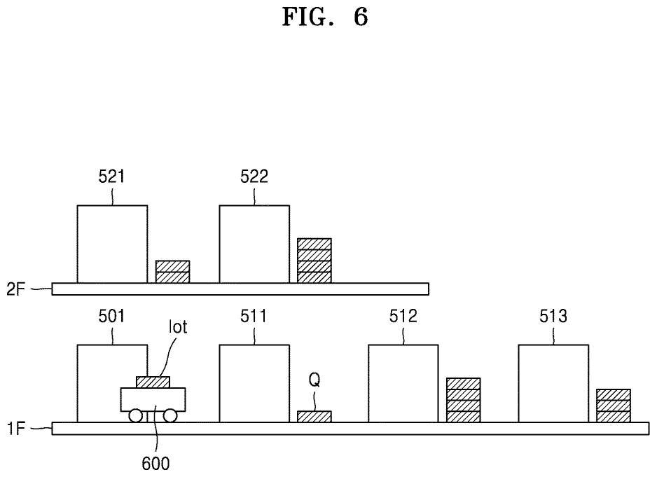

FIG. 5 is a flowchart schematically describing an execution operation of a digital twin simulation module according to an embodiment, and FIG. 6 is a diagram illustrating an example of facilities according to an embodiment.

Referring to FIG. 5, in the digital twin simulation model execution operation S130, the digital twin simulation module 310 may assign a rank to each of a plurality of facilities according to (based on) the operation rule received through the interface module 320 and select a first-rank (or highest-rank) facility as a work facility based on the rank (S131).

The digital twin simulation module 310 may determine whether the selected facility is in a facility constraint (i.e., Track In Prevent (TIP)) state (S132). When the selected facility is not in a facility constraint state, the process may be performed by using the selected facility as a work facility (S139). When the selected facility is in a facility constraint state, the digital twin simulation module 310 may determine whether the facility constraint is releasable, by considering the facility constraint switching condition (S133). When the facility constraint is releasable, the facility constraint may be released (S134) and the process may be performed by using the selected facility as a work facility (S139). When the facility constraint of the selected facility is not releasable, the digital twin simulation module 310 may select a next-rank facility according to (based on) the operation rule (S135).

The digital twin simulation module 310 may determine whether the selected next-rank facility is in a facility constraint state (S136). When the selected next-rank facility is not in a facility constraint state, the process may be performed by using the selected facility as a work facility (S139). When the selected next-rank facility is in a facility constraint state, the digital twin simulation module 310 may determine whether the facility constraint is releasable, by considering the facility constraint switching condition (S137). When the facility constraint is releasable, the facility constraint may be released (S138) and the process may be performed by using the selected facility as a work facility (S139). When the facility constraint of the selected facility is not releasable, the digital twin simulation module 310 may select a next-rank facility according to (based on) the operation rule (S135).

FIG. 6 is an illustrative diagram for describing facility switching based on an operation rule; however, the disclosure is not limited thereto. The type, number, arrangement, or the like of facilities and moving units may be variously modified. Referring to FIG. 6, the digital twin plant may include a moving unit 600 and a plurality of facilities obtained by reproducing the facilities of an actual plant in a digital environment. The moving unit 600 may transport a WIP lot from a facility to a next facility.

In an embodiment, as shown in FIG. 6, the plurality of facilities may include a first facility 501, a second facility 511, a third facility 512, a fourth facility 513, a fifth facility 521, and a sixth facility 522. The first facility 501 may be a facility for performing a first process, and the second to sixth facilities 511, 512, 513, 521, and 522 may be facilities for performing a second process performed after the first process. The moving unit 600 may transport the lot, which has passed through the first facility 501, to one of the second to sixth facilities 511, 512, 513, 521, and 522 based on the operation rule.

A plurality of operation rules may include a first operation rule, a second operation rule, a third operation rule, and a fourth operation rule. The first operation rule (that is, Operation rule 1) may assign a higher score to the facility as the number of lots in a queue decreases. The second operation rule (that is, Operation rule 2) may assign a score to the facility located on a same layer (or level) as the previous process facility and may not assign a score to the facility located on a different layer (or level). The third operation rule (that is, Operation rule 3) may assign a higher score to the facility as the distance between each facility and the previous process facility decreases. The fourth operation rule (that is, Operation rule 4) may assign the sum of the score based on the first operation rule, the score according to the second operation rule, and the score based on the third operation rule as a score of each facility.

TABLE 1

| | Operation | Operation | Operation | Operation |
|---|---|---|---|---|
| Facility | rule 1 | rule 2 | rule 3 | rule 4 |
| Second facility (511) | 30 | 1 | 50 | 81 |
| Third facility (512) | 10 | 1 | 12 | 23 |
| Fourth facility (513) | 20 | 1 | 12 | 33 |
| Fifth facility (521) | 15 | 0 | 55 | 70 |
| Sixth facility (522) | 10 | 0 | 25 | 35 |

In an embodiment, for example, based on operation rule 1, the second facility 511 with the highest score may be the highest-rank facility. Thus, the digital twin simulation module 310 may select the second facility 511 as a work facility and determine a facility constraint state of the second facility 511. When the second facility 511 is in a facility constraint state, the digital twin simulation module 310 may evaluate the facility constraint switching condition. When the facility constraint of the second facility 511 is releasable, the digital twin simulation module 310 may perform a work by using the second facility 511, and when the facility constraint of the second facility 511 is not releasable, the digital twin simulation module 310 may select the fourth facility 513, which is the next-rank facility, as a work facility. Based on operation rule 4, the second facility 511 may be the highest-rank facility and the fifth facility 521 may be the next-rank facility.

The digital twin simulation module 310 may output a daily production by performing work facility selection and facility switching based on the operation rule selected by the reinforcement learning module 330.

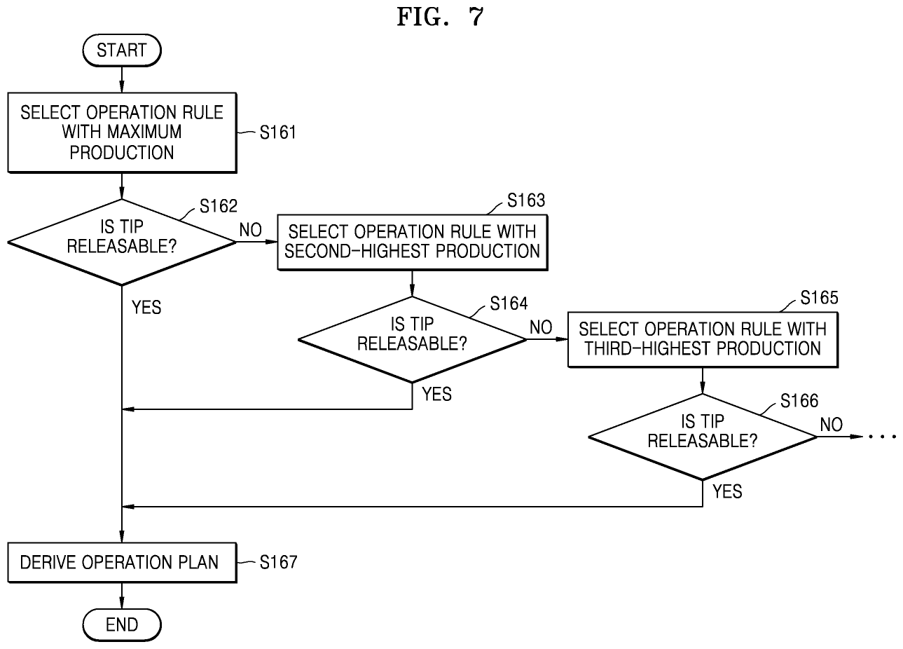

FIG. 7 is a flowchart schematically describing an operation plan derivation operation according to an embodiment.

Referring to FIG. 7, in an embodiment, the reinforcement learning module 330 may select an optimal operation rule with a maximum production derived by using Equation 1 (S161). In this case, the selected facility based on the optimal operation rule may be in a facility constraint (TIP) state. The reinforcement learning module 330 may determine whether the facility constraint of the selected facility is releasable (S162). When the facility constraint of the selected facility is releasable, the reinforcement learning module 330 may derive an operation plan based on an optimal solution (S167). When the facility constraint of the selected facility is not releasable, the reinforcement learning module 330 may select an operation rule with a second-highest production (S163).

The reinforcement learning module 330 may determine whether the facility constraint of the selected facility based on the operation rule with the second-highest production is releasable (S164). When the facility constraint of the selected facility is releasable, the reinforcement learning module 330 may derive an operation plan based on an optimal solution (S167). When the facility constraint of the selected facility is not releasable, the reinforcement learning module 330 may select an operation rule with a third-highest production (S165). The reinforcement learning module 330 may determine whether the facility constraint of the selected facility based on the operation rule with the third-highest production is releasable (S166). In other words, the reinforcement learning module 330 may determine a next-best operation rule that is applicable when the facility constraint of the selected facility based on the higher-rank operation rule with the higher-production is not releasable.

By using Equation 3 below, the reinforcement learning module 330 may estimate an expected reward Q_{k,i}(s, a; θ) by using an n-th-greatest value among upper k expected rewards (Q(s′, a′; θ)) of the next operation state s′.

Q_{k,i}(s, a; θ)=E[(r+γ×SortQ(s′, a′; θ−)[i])] [Equation 3]

Here, SortQ(s′, a′; θ−) denotes a descending-order sort of the upper k expected rewards Q(s′, a′; θ) of the next operation state s′, and [i] denotes an i-th value in the sorted list. Here, i may be a natural number greater than or equal to 0, and i=n-1.

For example, the second-greatest expected reward may be Q_{k,1}(s, a; θ)=E[(r+γ×SortQ(s′, a′; θ⁻)[1])], and the third-greatest expected reward may be Q_{k,2}(s, a; θ)=E[r+γ×SortQ(s′, a′; θ⁻)[2] An expected value Vₖ(s) may be represented as Equation 4 below.

Vₖ(s)=E[(r+γ×Q(s, a; θ))][Equation 4]

As such, the reinforcement learning module 330 may derive and propose an n-th-rank operation rule by using the n-th-greatest expected reward as the expected value instead of selecting the maximum expected reward maxQ(s′, a′; θ) as the optimal solution.

As a comparative example, when a reinforcement learning module obtains only an optimized solution, the adoptability and applicability of an operation plan may be lowered by proposing an operation plan that does not consider the operation of an actual production line. According to an embodiment, the reinforcement learning module 330 may improve the adoptability and applicability of the operation plan by proposing the next-best operation plan when the operation of the selected facility is impossible due to the facility constraint.

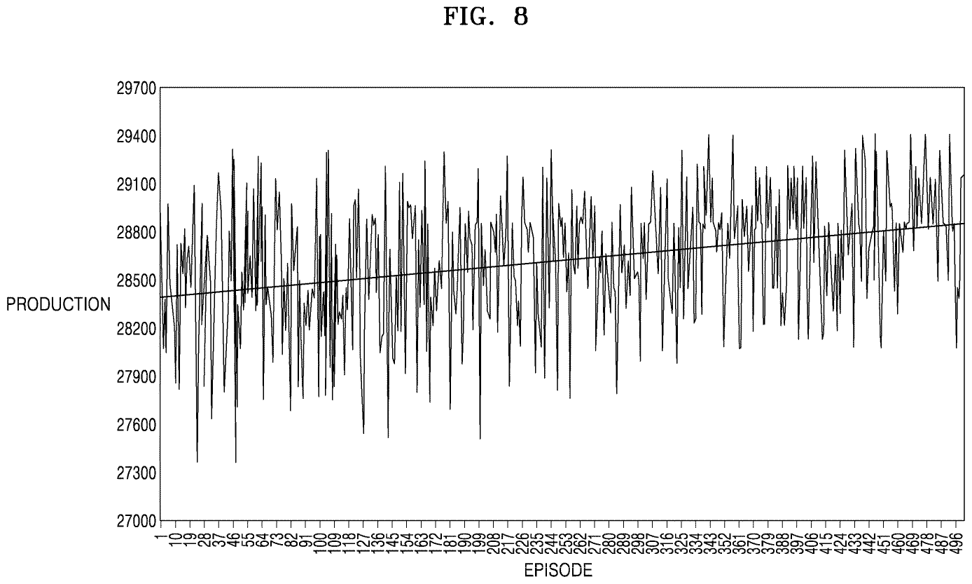

FIG. 8 is a graph illustrating a learning curve of a reinforcement learning module according to an embodiment.

The learning of the reinforcement learning module of FIG. 8 may be performed on a drying unit process, and the hyperparameters used in the reinforcement learning module may be the same as those in Table 2 below.

TABLE 2

| Hyper parameters | Value |
|---|---|
| Discount Factor(γ) | 0.99 |
| Learning rate(η) | 0.001 |
| Mini batch size(transitions per batch) | 32 |
| εₘᵢₙ (Minimum probability of exploration) | 0.01 |
| replay memory(transitions) | 10,000 |
| Episodes (times) | 500 |

Referring to FIG. 8, the reinforcement learning module repeats about 500 episodes, and it may be seen that the final production corresponding to the reward thereof increases gradually based on the progress of the episodes.

TABLE 3

| Day | 1 | 2 | 3 | 4 | 5 | 6 | 7 | 8 | 9 | 10 |
|---|---|---|---|---|---|---|---|---|---|---|
| Episode 48 | 3 | 4 | 1 | 1 | 1 | 2 | 2 | 1 | 3 | 3 |
| Episode 302 | 4 | 1 | 1 | 1 | 1 | 1 | 1 | 4 | 1 | 1 |
| Episode 357 | 4 | 1 | 1 | 1 | 1 | 3 | 2 | 3 | 3 | 3 |

An operation plan is derived in which a 375th episode among all the episodes has the highest final production. For example, an optimal operation plan is derived to apply operation rule 4 on the first day of the simulation, apply operation rule 1 on the second to the fifth days, apply operation rule 3 on the sixth day, apply operation rule 2 on the seventh day, and apply operation rule 3 on the eighth to the tenth days.

TABLE 4

| | | TIP release | Number of glasses |
|---|---|---|---|
| Index | Operation plan | count (pieces) | (sheets) |
| 0 | No release | 0 | 26,706 (5.5% ↓) |
| 1 | Operation rule 1 | 64 | 28,270 (0%) |
| 2 | Operation rule 2 | 32 | 28,039 (0.8% ↓) |
| 3 | Operation rule 3 | 26 | 27,700 (2.0% ↓) |
| 4 | Operation rule 4 | 64 | 28,270 (Standard) |
| 5 | Optimal operation plan | 47 | 29,403 (4.0% ↑) |

Table 4 shows the digital twin simulation results in the case of applying the optimal operation plan derived by the reinforcement learning module to the drying unit process and in the case of applying different operation rules for 10 days without any change.

It may be seen that the number of glasses increases by 1,133 sheets and thus the final production is improved by 4.0% in the case of applying the optimal operation plan derived by the reinforcement learning module, compared to the case of simply applying operation rule 4 for 10 days. Also, it may be seen that the facility constraint release count is reduced by about 27% to increase the production and allow efficient management of the facility constraint.

The operation optimization system according to an embodiment may be applied not only to unit processes but also to the entire process for product production. Compared to a case of performing optimization by applying the operation optimization system to only one unit process, in the case of applying the operation optimization system to the entire process, the final production increases further by 1.1% and thus the final production increases by a total of 5.2%.

As described above, according to an embodiment, an operation optimization system for deriving an optimal operation plan by considering a facility constraint (i.e., TIP), and a facility operation system including the operation optimization system may be implemented. According to an embodiment, by using the operation optimization system and the facility operation system including the operation optimization system, facility operation and decision making may be supported to improve the production of a production line.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An operation optimization system comprising:
a digital twin simulation module which performs a digital twin simulation based on an operation rule, real-time data, and a facility constraint switching condition and outputs daily production operation information;
a reinforcement learning module which selects one of a plurality of operation rules, learns a selection for maximizing a final production for a certain period based on the daily production operation information of the digital twin simulation performed based on the selected operation rule, and determines an operation plan by using a learned algorithm; and
an interface module which transmits information between the digital twin simulation module and the reinforcement learning module.

2. The operation optimization system of claim 1, wherein the digital twin simulation module assigns a rank to each of a plurality of facilities based on the selected operation rule and selects a work facility based on the rank.

3. The operation optimization system of claim 2, wherein the digital twin simulation module selects a facility with a highest rank among the plurality of facilities as the work facility and evaluates the facility constraint switching condition of the selected facility to perform a work with the selected facility or to select a next-rank facility as the work facility.

4. The operation optimization system of claim 1, wherein the reinforcement learning module selects one of the plurality of operation rules per day for one episode including the certain period,
the digital twin simulation module outputs the daily production operation information based on the selected operation rule, and
the reinforcement learning module repeatedly learns a plurality of episodes and determines a combination of the operation rules which maximizes the final production as the operation plan.

5. The operation optimization system of claim 4, wherein the reinforcement learning module generates an operation state based on the daily production operation information, predicts an expected reward obtained by selecting one of the plurality of operation rules in the operation state, and learns by comparing the expected reward with a daily production of the daily production operation information.

6. The operation optimization system of claim 5, wherein the reinforcement learning module stores, in a replay memory, experiences obtained in a learning process and learns by randomly sampling a mini-batch from the replay memory.

7. The operation optimization system of claim 5, wherein the reinforcement learning module comprises a main network and a target network, and
the target network copies a weight of the main network at certain periods, maintains the copied weight until a next period, and outputs a maximum expected reward.

8. The operation optimization system of claim 7, wherein the reinforcement learning module further comprises a loss calculator which calculates a loss function based on a difference between the expected reward and the maximum expected reward and updates the weight of the main network based on the calculated loss.

9. The operation optimization system of claim 7, wherein the main network estimates an expected reward in an operation state based on the maximum expected reward.

10. The operation optimization system of claim 7, wherein the reinforcement learning module estimates an n-th-rank expected reward based on an n-th-greatest value among expected rewards of a next operation state, wherein n is a natural number equal to or greater than 1.

11. The operation optimization system of claim 4, wherein the reinforcement learning module determines a next-best operation rule which is applicable when a facility constraint of a selected facility based on the operation rule is not releasable.

12. A facility operation system comprising:
a data collection system which collects real-time data from a production line;
a data management system which stores the real-time data; and
an operation optimization system which performs a digital twin simulation based on the real-time data and determines an operation plan of the production line based on result values of the digital twin simulation,
wherein the operation optimization system comprises:
a digital twin simulation module which performs a digital twin simulation based on an operation rule, the real-time data, and a facility constraint switching condition and outputs daily production operation information;
a reinforcement learning module which selects one of a plurality of operation rules, learns a selection for maximizing a final production for a certain period based on the daily production operation information of a digital twin simulation performed based on the selected operation rule, and determines an operation plan by using a learned algorithm; and
an interface module which transmits information between the data management system, the digital twin simulation module, and the reinforcement learning module.

13. The facility operation system of claim 12, wherein the interface module transmits the real-time data from the data management system to the digital twin simulation module, transmits the daily production operation information from the digital twin simulation module to the reinforcement learning module, and transmits the selected operation rule from the reinforcement learning module to the digital twin simulation module.

14. The facility operation system of claim 12, wherein the data collection system comprises sensors and an Internet of Things network.

15. The facility operation system of claim 12, wherein the data management system stores facility information, product information, plan information, process information, and operation information.

16. The facility operation system of claim 12, wherein the digital twin simulation module assigns a rank to each of a plurality of facilities based on the selected operation rule and selects a work facility based on the rank.

17. The facility operation system of claim 16, wherein the digital twin simulation module selects a facility with a highest rank among the plurality of facilities as the work facility and evaluates the facility constraint switching condition of the selected facility to perform a work with the selected facility or to select a next-rank facility as the work facility.

18. The facility operation system of claim 12, wherein the reinforcement learning module selects one of the plurality of operation rules per day for one episode including the certain period,
the digital twin simulation module outputs the daily production operation information based on the selected operation rule, and
the reinforcement learning module repeatedly learns a plurality of episodes and determines a combination of the operation rules which maximizes the final production as the operation plan.

19. The facility operation system of claim 18, wherein the reinforcement learning module generates an operation state based on the daily production operation information, predicts an expected reward obtained by selecting one of the plurality of operation rules in the operation state, and learns by comparing the expected reward with a daily production of the daily production operation information.

20. The facility operation system of claim 18, wherein the reinforcement learning module determines a next-best operation plan which is applicable when a facility constraint of a work facility based on the operation plan is not releasable.
